(19) United States
(12) Patent Application Publication
(10) Pub. No.: US 2015/0371563 A1
(43) Pub. Date: Dec. 24, 2015

(54) Supplemental Label

(71) Applicant: David Waugh, Lawrenceville, GA (US)

(72) Inventor: David Waugh, Lawrenceville, GA (US)

(21) Appl. No.: 14/310,931

(22) Filed: Jun. 20, 2014

(51) Int. Cl. G09F 3/02

(52) U.S. Cl. CPC G09F 3/02; G09F 2003/0201; G09F 2003/0241; G09F 2003/0239; G09F 2003/0269; G09F 2003/0267; G09F 2003/0257; G09F 2003/0214

(57) ABSTRACT

A sheet having a supplemental label according to an embodiment includes a presentation portion having a print receptive front face and a coupling portion coupled to the presentation portion. The coupling portion is a transparent composite film made of an upper film, a repositional adhesive, a release agent, another layer of film, and an adhesive which is joined to a substrate such as paper or other print receptive media.

### CROSS-REFERENCE TO RELATED APPLICATION

This application claims priority from U.S. Provisional Application 61/837,335 filed Jun. 20, 2013, which is incorporated herein by reference in its entirety.

### BACKGROUND OF THE INVENTION

The present invention relates generally to labels, and more particularly to retail supplemental labeling with printed labels, for promotional or advertising purposes.

The typical retail market includes aisles of shelves on which different products are displayed. Each shelf includes an edge facing the consumer in which individual product labels are adhered. The typical supplemental label is sized such that it fits along the edge of the shelf and generally includes a pressure sensitive adhesive on the back side of the label so that a bond forms with the shelf edge, or alternatively has a flange that joins with a channel or other holding mechanism. An example of the flange or integral tab is taught in U.S. Pat. No. 3,753,305 [Mueh].

A supplemental retail shelf label, sometimes called “shelf talker” is used for providing information about a product, such as price, size, etc. displayed above. The shelf talker is a supplemental label, generally larger than a shelf label and has a presentation portion with additional information about the product. Shelf talkers are typically provided in groups of similar size on individual sheets of pressure sensitive adhesive protected by a liner. Additional information, including the specific product, size, and promotional price, is printed on each of the supplemental labels on an individual sheet using a suitable printer including thermal transfer, laser, and direct thermal printers. Shelf talkers are used most frequently to garner a potential customer's attention to alert them that a particular item is on sale.

Because supplemental labels are intended to be temporary, they should be easy and economical to produce, install, and remove, and as well as being durable enough to withstand the intended application in a retail or wholesale advertising or marketing environment.

Traditional manufacture of pressure sensitive adhesive stock for labels is performed by providing a layer of face material or a substrate for the label which is backed by a coating of pressure sensitive adhesive. This label is subsequently covered by a release liner or carrier which is commonly a silicone or wax coated paper. The liner or carrier protects the adhesive during shipment and storage and allows for efficient handling and stiffness of an array of individual labels up to the point where the individual labels can be properly dispensed.

A disadvantage of this method is the occurrence of delamination during printing. Delamination happens when the labels are pre-cut prior to the printing process. The labels can delaminate or lift off from the liner while moving through the printing or imaging process. This can cause jams and contamination (such as when the exposed adhesive contacts the rollers of the device) within the machine resulting in costly downtime for the user for cleaning and maintenance.

Solving the printing reliability problem also poses a challenge in post printing since reliably adhering the label to the liner also causes difficulty for the end user to remove the label from the sheet. Perforating labels along their perimeter allows the labels to be removed from the sheet.

Some supplemental labels use a pattern of adhesives on a coupling film such that a permanent adhesive joins the presentation portion of the label to the mounting film and a repositionable adhesive to mount the label to a shelf edge. The method described in this application is simpler to produce.

Shelf talkers that use a flange or integral tab in the label itself correspondingly increases the cost of manufacture of the label, as well as reduces the available surface area of the label for printing desired product information thereon. The tab may be formed by a three edge diecut in the label, and printing thereon is not desired in view of the discontinuity provided by the diecut.

Furthermore, the die cut tab can create feed problems in printers having circuitous travel paths. As the label or sheet of labels bends around narrow rollers in the feedpath, the diecut may expose the cut edges which may snag during feeder travel. This can cause jamming or skewing of the label during printer travel rendering the specific label unusable and requiring remedial action when the printer jams.

Accordingly, it is desired to provide an improved supplemental label which eliminates die cutting of the label itself and retains the full surface area of the label for printing of desired promotional information. Labels and manufacturing methods set forth herein include novel improvements to the prior art labels and manufacturing methods.

### SUMMARY

Disclosed is a sheet having a supplemental label according to an embodiment includes a presentation portion having a print receptive front face and a coupling portion coupled to the presentation portion. The coupling portion is a transparent composite film made of an upper film, a repositional adhesive, a release agent, another layer of film, and an adhesive which is joined to a substrate such as paper or other print receptive media. An example of a layering of a composite film similar the coupling film in this description is disclosed in U.S. Pat. No. 6,022,051 [Casagrande]. There are perforations within the carrier sheet making the perimeter of supplemental labels, and diecuts on the back side of the carrier sheet that penetrate through the first layer of film that create a removable portion which once removed exposes a repositional adhesive allowing the supplemental label to be mounted on a shelf edge.

An alternative embodiment has the composite film used for the coupling portion is opaque.

An alternative embodiment has the front face of the composite film used for the coupling portion is a print receptive surface.

An alternative embodiment has the carrier sheet substrate that the coupling portion is coupled to is indented in the area where the coupling portion will be joined to the substrate so as to permit the upper surface of the coupling portion to rise to the same or very similar height as the substrate, that is, that the thickness of the substrate will be equal to, or very near equal to the thickness of the substrate joined with the coupling portion at the location where the coupling portion is joined to the substrate.

### DRAWINGS

FIG. 1 is a front view of a supplemental label 100

FIG. 2 is a back view of a supplemental label 100

FIG. 3 is an illustration of one embodiment of a supplemental label 100 in use

FIG. 4 is a front view of a composite sheet 400 of supplemental labels 100

FIG. 5 is an illustration of one Pre-Form supplemental label 500 removed from a composite sheet 400

FIG. 6 is a back view of a composite sheet 400

FIG. 7 is a perspective view of the front side of a Pre-Form supplemental label 500

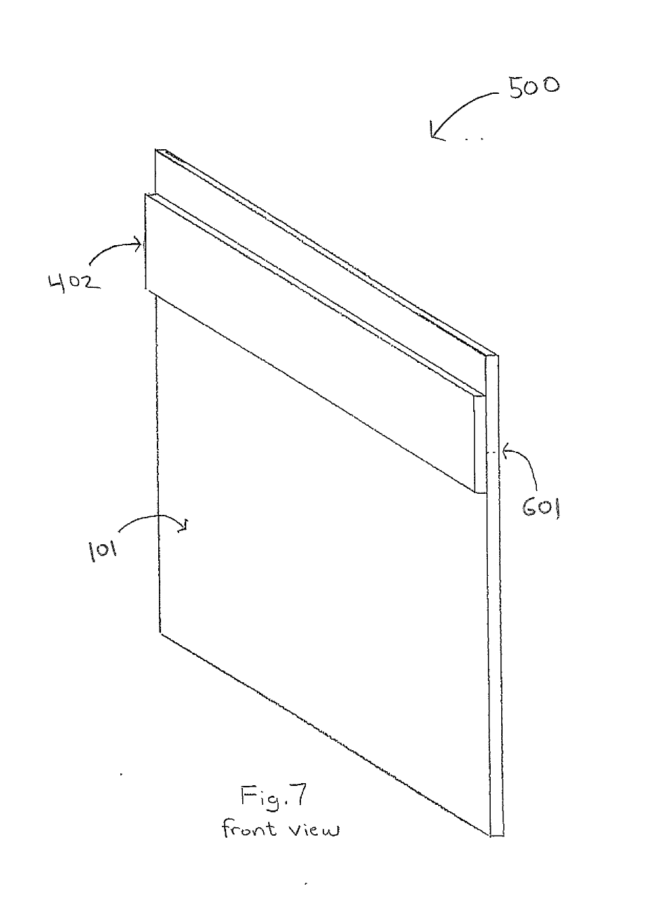

FIG. 8 is a perspective view of the back side of a Pre-Form supplemental label 500

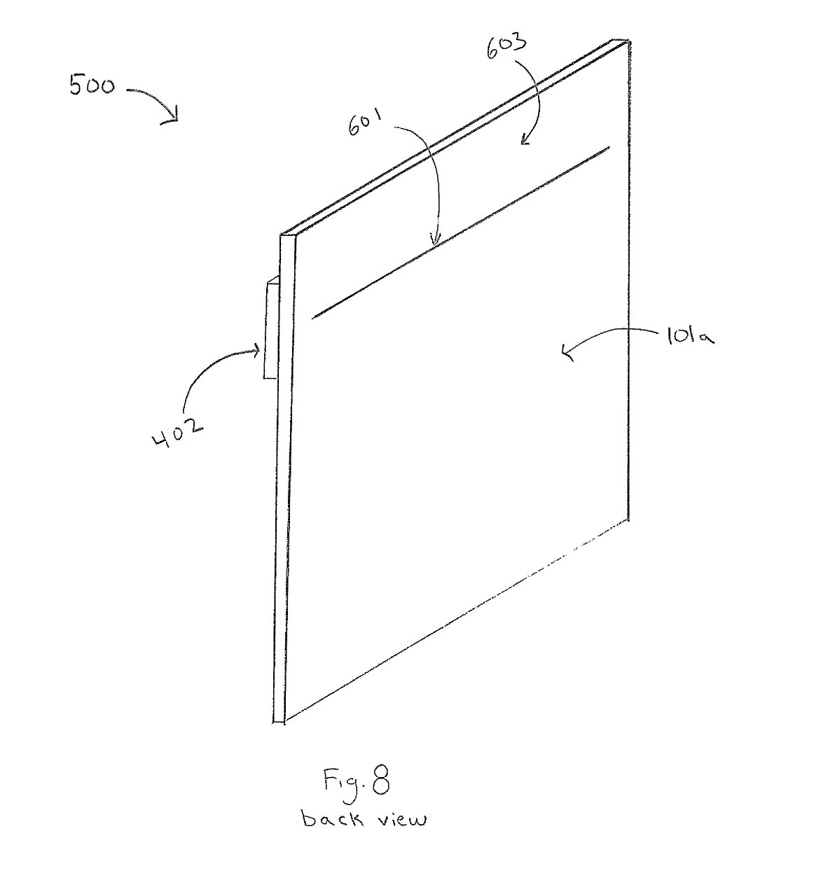

FIG. 9 is a perspective view of the back side of a supplemental label 100, illustrating the removal of the removable portion 603 from the Pre-Form supplemental label 500

FIG. 10 is a side view illustrating the layers of the composite film 402

FIG. 11 is a side view illustrating the separation of the removable portion 603 and forming a supplemental label 100

FIG. 12 is a perspective view of the front side of an alternative embodiment that is indented in the area of the carrier sheet 104 corresponding to the placement of the composite film 402.

### REFERENCE NUMERALS USED IN DRAWINGS

100 A supplemental label
101 Presentation portion of the supplemental label
101a The back side of a carrier sheet 104
102 Coupling portion of a supplemental label
103 Front surface of a coupling portion 102
103a Rear surface of the coupling portion 102
104 Carrier sheet
400 A composite sheet of supplemental labels 100
401 The perforation that makes the perimeter of a supplemental label 100
402 The composite film that makes a coupling portion 102
500 Pre-Form supplemental label: the part of a composite sheet 400 that will make a supplemental label 100 after the removable portion 603 of a carrier sheet 104 is removed
601 Diecut on the back side of a Pre-Form supplemental label 500.
602 The space between diecuts 601
603 The removable portion of a Pre-Form Supplement Label 500
1001 Upper layer of film of composite film 402
1002 Repositional adhesive layer of composite film 402
1003 Release agent layer of composite film 402
1003a Release agent layer which remains on removable portion 603
1004 Lower layer of film of composite film 402
1004a Lower layer of film which remains on removable portion 603
1005 Adhesive layer of composite film 402
1005a Adhesive layer which remains on removable portion 603

### DETAILED DESCRIPTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

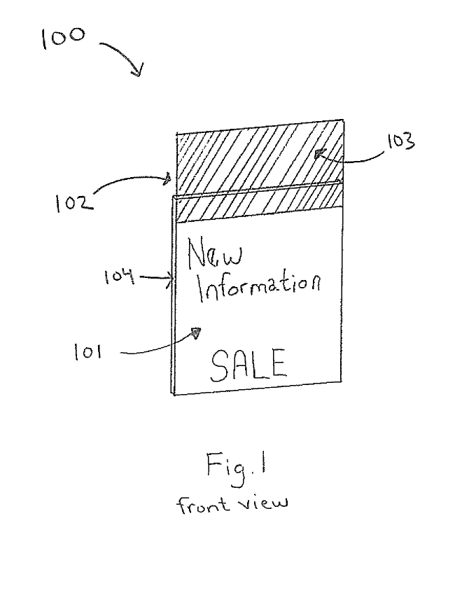

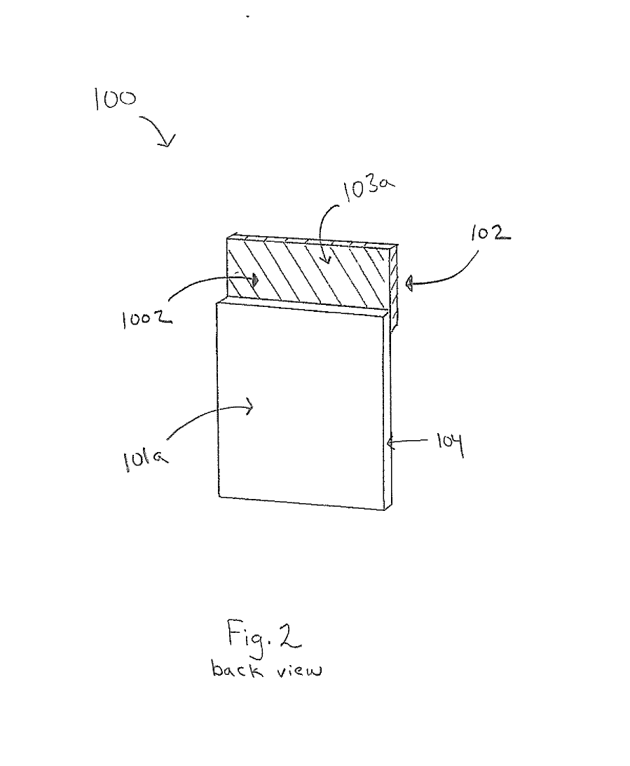

FIGS. 1 through 6 and 11 show an embodiment of a new supplemental label 100 having a presentation portion 101 and a coupling portion 102. The presentation portion 101 has front face 101 (FIG. 1) and a rear face 101a (FIG. 2). The front face 101 may include an area appropriate for being printed on, such as a blank or other field, so that information (e.g., price information, etc.) may be later printed on the area. The front face may alternately or additionally include indicia that does not readily lend the front face to being printed on. For example, the front face may include graphics that would cause any additional printed material to be illegible or inconspicuous.

The presentation portion 101 is shown as a single layer of material for the carrier sheet 104 (e.g., paper, card stock, synthetic substrate, etc.) though additional layers may be included. The carrier sheet 104 may be any print receiving substrate, such as paper, cardstock, synthetic print-receptive substrate, etc., though inexpensive materials may be preferred and the carrier sheet may include various component materials.

The coupling portion 102 is shown to be a clear film having top and bottom ends and opposed sides. While the ends and sides of the coupling portion are shown to collectively be generally rectangular and the coupling portion 102 is shown to have a width that is approximately equal to a width of the presentation portion 102, non-rectangular configurations and/or widths may alternately be defined. As shown throughout the drawings, the coupling portion sides may be unbounded beyond the presentation portion end. In other words, it is not necessary to provide a border around the coupling portion sides, though such a border may be used.

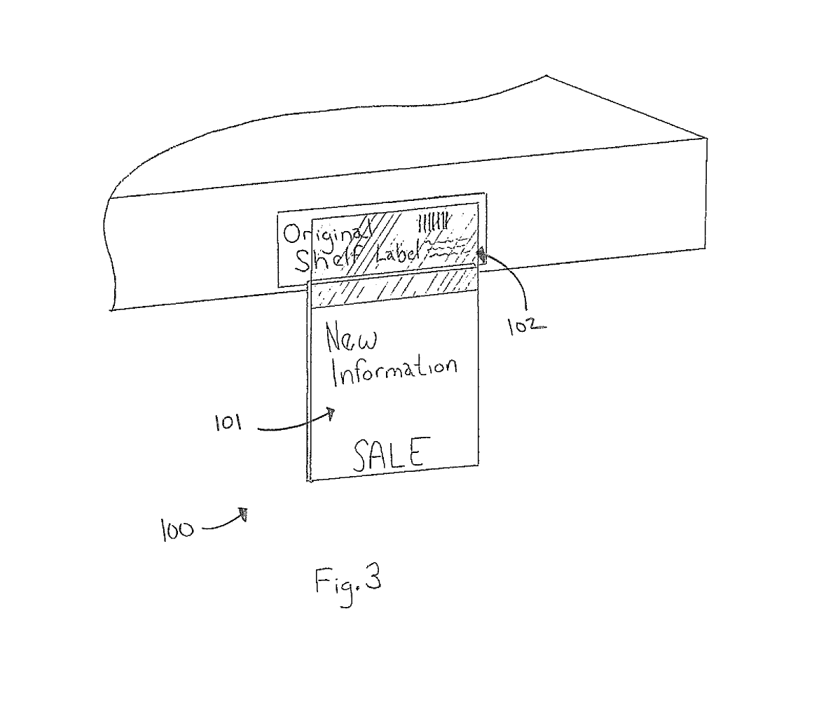

The coupling portion 102 has a front face 103 and a rear face 103a. The rear face has a repositional adhesive 1002 (i.e., transparent repositional pressure sensitive adhesive) that may be used to couple the coupling portion 102 to an object. For example, FIG. 3 shows the adhesive 1002 coupling the coupling portion 102 to a store shelf over another label. The composite film 402 that becomes the coupling portion may be sized to only partially attach to the presentation portion as shown in FIG. 1 or may be sized to cover the entire presentation portion 101 of the supplemental label 100.

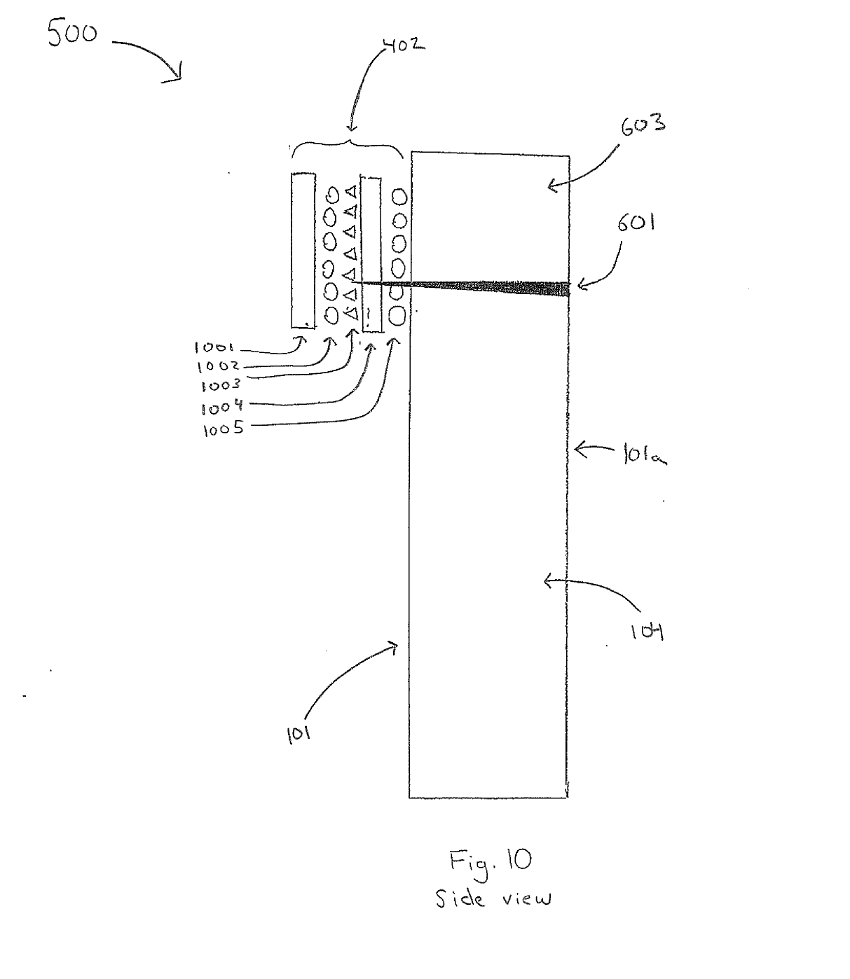

The coupling portion 102 is derived from a composite film 402 (FIG. 10) that has an upper film layer 1001, a layer of repositional adhesive 1002 (which may require a release agent 1003 to work correctly) and a lower layer of film 1004 which divides the repositional adhesive 1002 from the permanent adhesive 1005 at the lowest level of the film which then permanently affixes to the carrier sheet 104.

While the shape of the presentation portion 101 of a supplemental label 100 and the supplemental label 100 itself is shown to collectively be generally rectangular, non-rectangular configurations may alternately be defined.

Material for the presentation portion 101 of the supplemental label 100 may be chosen for printability, durability, color, shade, opacity, and/or other properties that are required or suitable for particular applications. Material for the face layer 103 of the composite film 402 used for the coupling portion 102 may be chosen for transparency, printability, durability, and/or other properties that are required or suitable for particular applications.

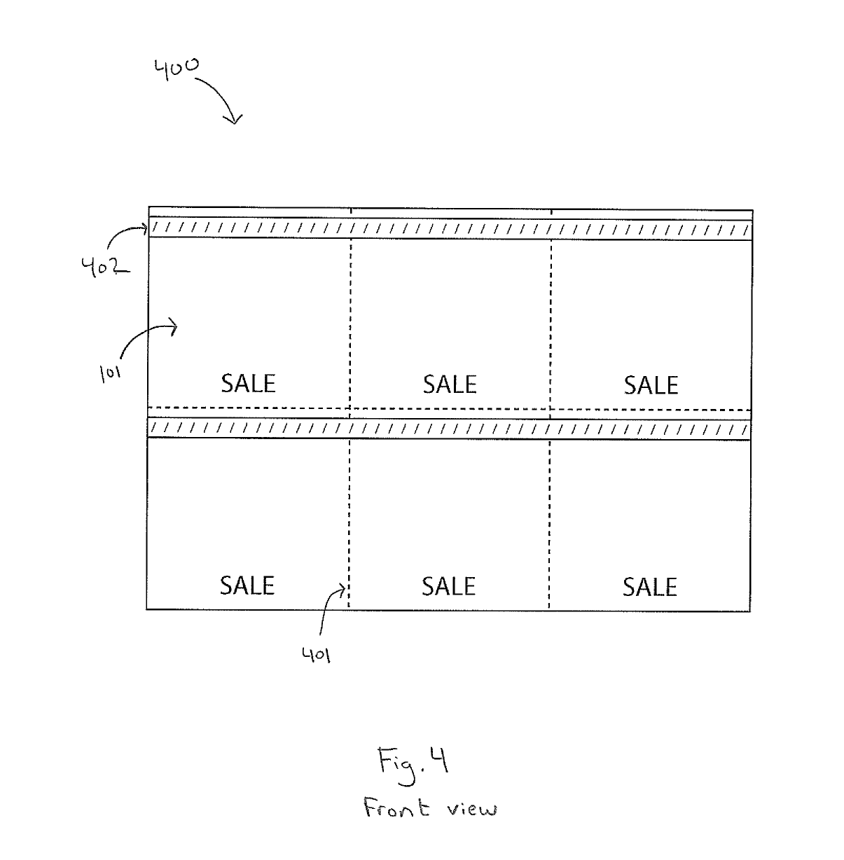

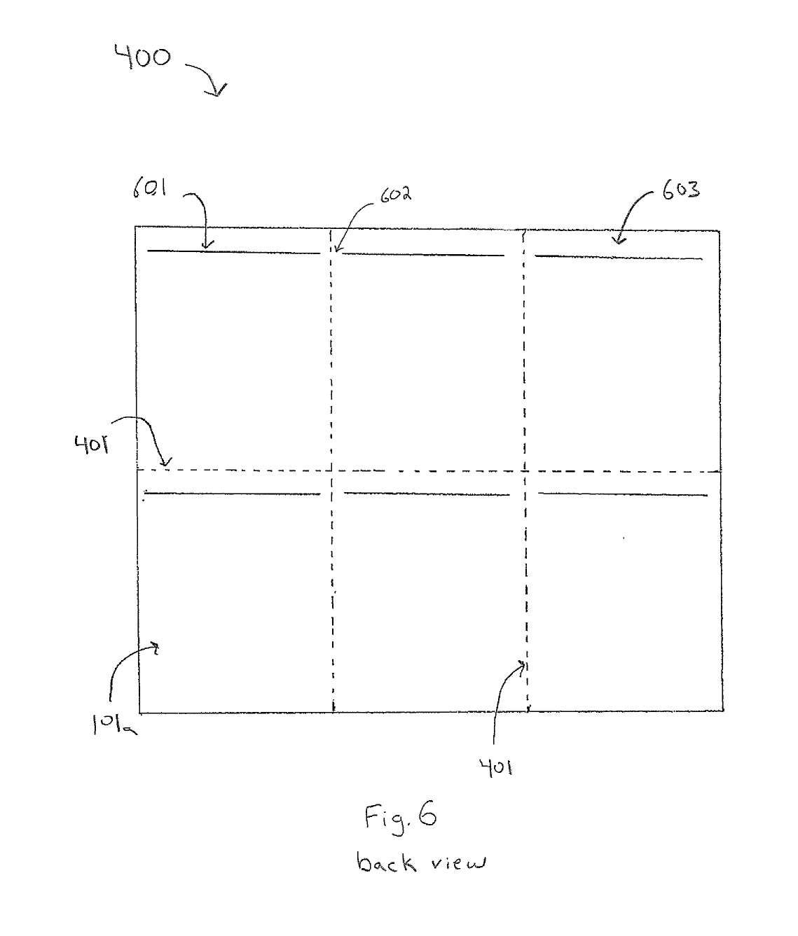

FIGS. 4 through 6 show a composite sheet 400 of supplemental labels 100 according to an embodiment. The composite sheet 400 may be 8.5 inches by 11 inches, or 8.5 by 14 inches, or any other appropriate size. The composite sheet is made from a carrier sheet 104 of paper or other print receptive substrate and a composite film 402 applied in strips in areas that will become the coupling portion 102 on the top portion of a supplemental label 100. The strips of composite film 402 will be applied as needed for the number and arrangement of supplemental labels 100 that meets the requirements. Next perforations 401 are made into the carrier sheet 104 that will mark the perimeter of the supplemental labels 100 contained within the sheet 400. A series of diecuts 602 are made into the back face 101a of the composite sheet 400 such that the die cut penetrates the carrier sheet 104, the permanent adhesive 1005 and the lower film layer 1004. In an embodiment shown in FIG. 6, the width of the die cut is less than the width of the supplemental label 100 which facilitates holding the removable portion 603 of the carrier sheet 104 in place during printing or other processing.

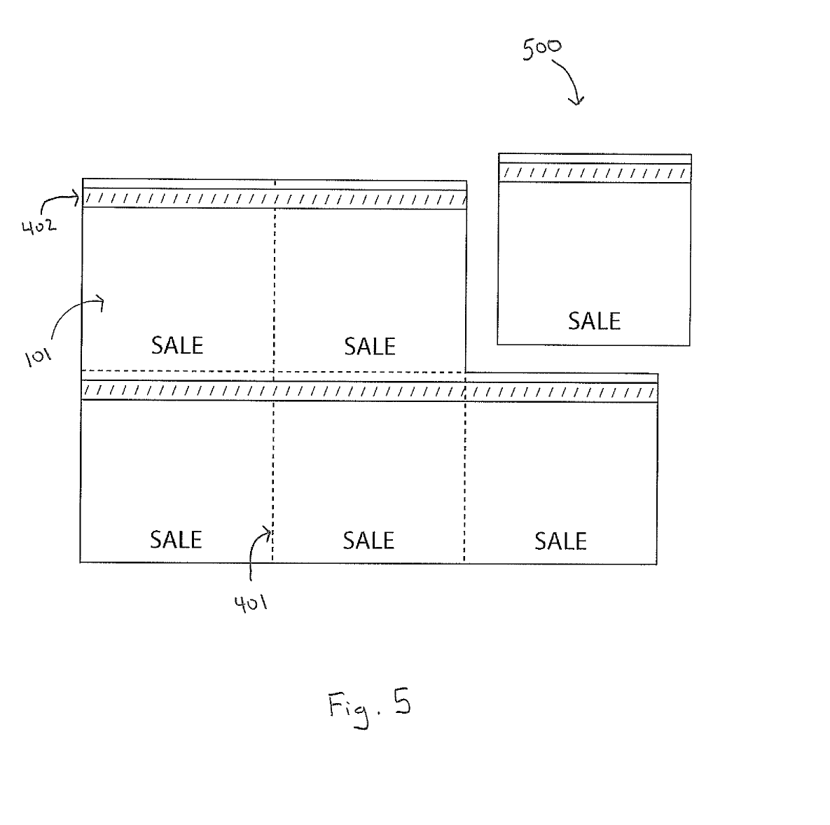

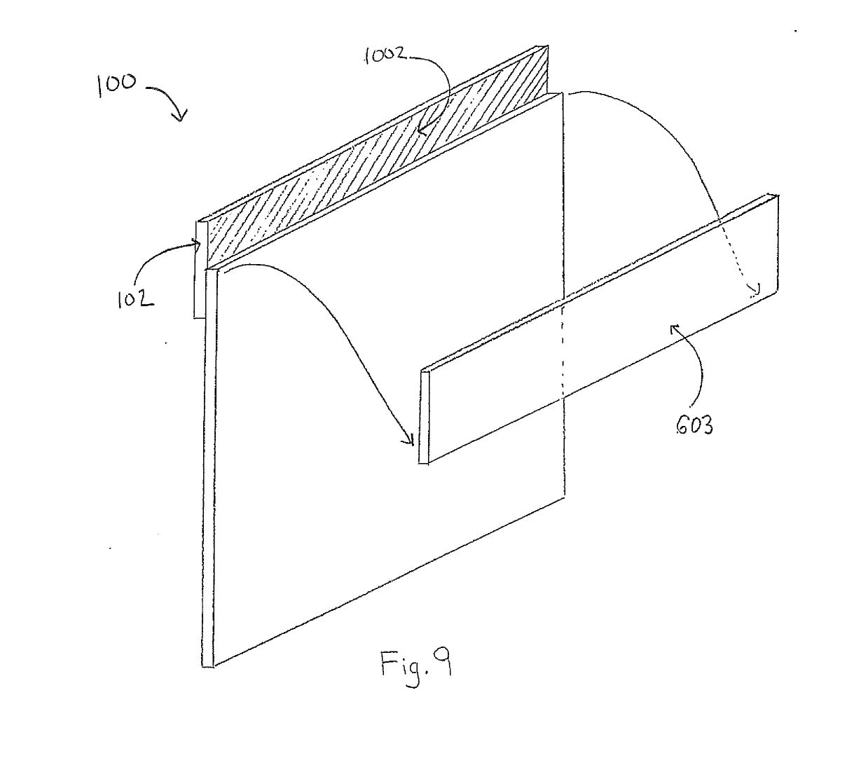

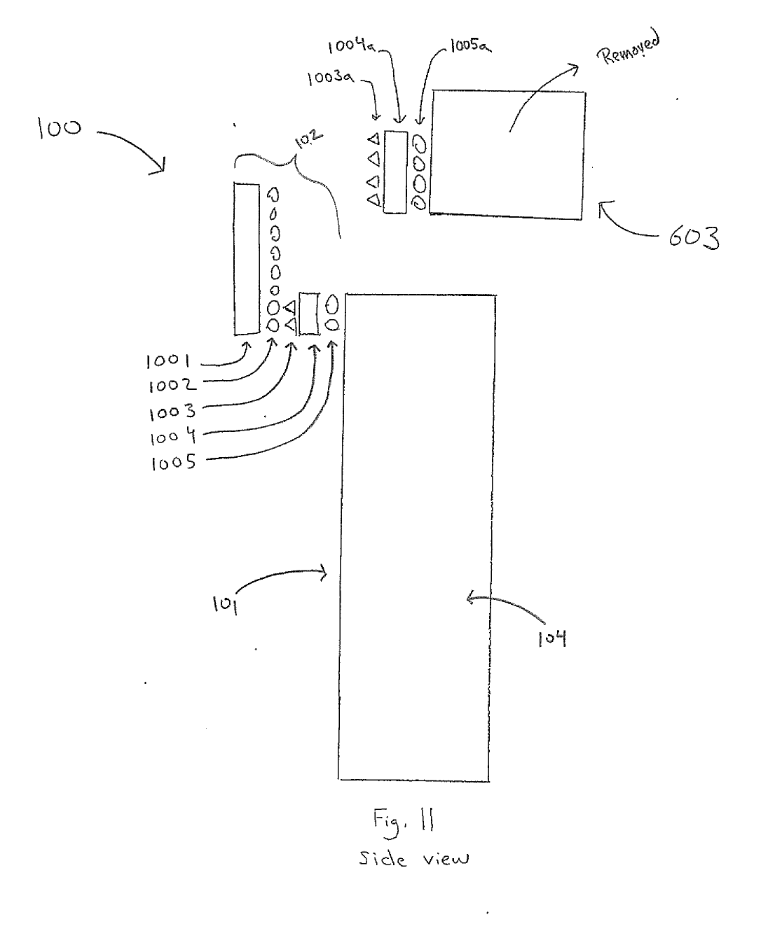

FIG. 5 shows a single Pre-Form supplemental label 400 is separated from the composite sheet 400 by separating the perforation 401. FIG. 9 shows the removable portion 603 of the carrier sheet 104 being removed from the Pre-Form supplemental label 500 so that it is a function supplemental label 100 with a presentation portion 101 and a coupling portion 102 with an exposed repositional adhesive 1002 on the rear face 103a of the coupling portion 102. FIG. 11 shows the residual components 1003a, 1004a, 1005a of the removable portion 603 of the carrier sheet after being separated from the Pre-Form supplemental label 500.

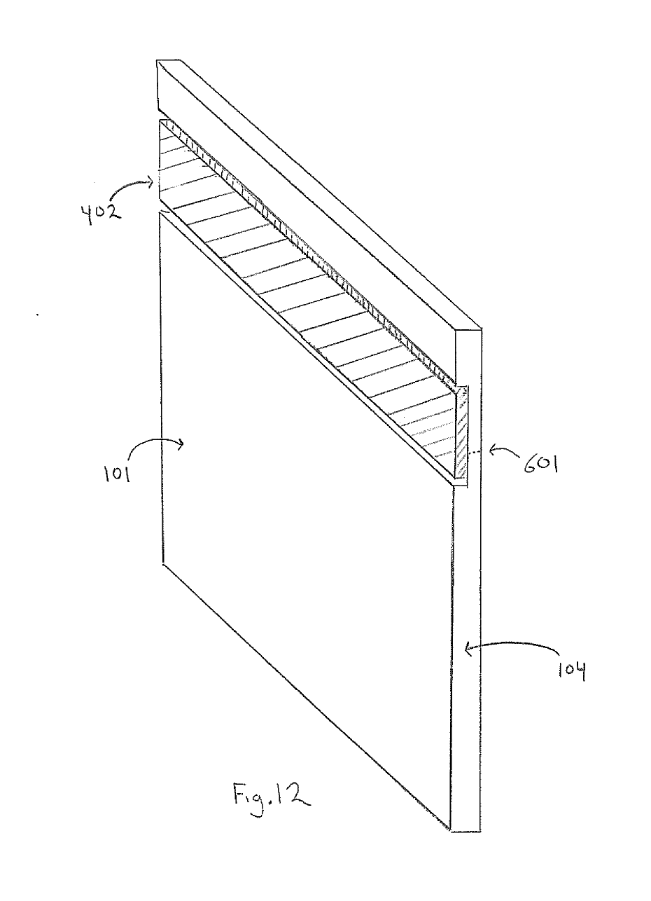

FIG. 12 shows an alternate embodiment of supplemental label 100 that has an indentation within the carrier sheet 104 that corresponds to the placement of the composite film 402 that becomes the coupling portion 102 when the removable portion 603 is removed.

Those skilled in the art appreciate that variations from the specified embodiments disclosed above are contemplated herein and that the described embodiments are not limiting. The description should not be restricted to the above embodiments, but should be measured by the following claims.

1. A sheet of supplemental labels for use in a printer to print product information thereon for display, for removable attachment to an object comprising:
a plurality of supplemental labels arranged in a group in a common sheet for being passed through said printer to print said product information thereon;
and being constructed of:
a carrier sheet of a print receptive substrate; and
a composite film comprising a top layer of film, a layer of repositional adhesive, an inner layer of film, and a lower layer of permanent adhesive; and
having perforations on the carrier sheet spaced apart a selected distance, said perforations defining the perimeter of said supplemental labels within said carrier sheet; and
a diecut imposed on the rear face of the carrier sheet, said diecuts penetrate the carrier sheet, permanent adhesive layer and lower film layer which divides the permanent adhesive from the repositional adhesive so that when a portion of the carrier sheet below the composite film and adjacent to said diecut is removed, a repositional adhesive is exposed on the rear face of the upper layer film of said composite film, forming a coupling portion and presentation portion

2. A sheet of supplemental labels of claim 1, wherein said composite film contains a layer of release agent between a layer of inner film and layer of repositional adhesive.

3. A sheet of supplemental labels of claim 1, wherein said composite film is transparent.

4. A sheet of supplemental labels of claim 1, wherein said composite film is opaque; and the front face of the composite film is print receptive.

5. A sheet of supplemental labels of claim 1, wherein said the front face of said composite film is print receptive.

6. A sheet of supplemental labels of claim 1, wherein said carrier sheet is indented in an area corresponding to the placement of said composite film whereby said the thickness of the sheet of supplemental labels is nearly equal at position of the composite film as it is where the composite film is not present.
